(19) United States
(12) Patent Application Publication
(10) Pub. No.: US 2021/0170672 A1
(43) Pub. Date: Jun. 10, 2021

(54) THREE-DIMENSIONAL PRINTER

(71) Applicants: Seong Jin PARK, Seogwipo-si (KR); Hong Joo LEE, Seoul (KR); Hwan Ook JU, Yongin-si (KR)

(72) Inventors: Seong Jin PARK, Seogwipo-si (KR); Hong Joo LEE, Seoul (KR); Hwan Ook JU, Yongin-si (KR)

(21) Appl. No.: 16/071,903

(22) PCT Filed: Jan. 23, 2017
(86) PCT No.: PCT/KR2017/000783

§ 371 Date: Jul. 21, 2018

(30) Foreign Application Priority Data
Jan. 22, 2016 (KR) 10-2016-0008353

(51) Int. Cl. B29C 64/124; B29C 64/35; B29C 64/277; B29C 64/307; B33Y 30/00; B33Y 40/00

(52) U.S. Cl. CPC B29C 64/124; B29C 64/35; B33Y 40/00; B29C 64/307; B33Y 30/00; B29C 64/277

(57) ABSTRACT

The present invention relates to a three-dimensional printer. According to an embodiment of the present invention, the printer comprises a plurality of tanks, and can manufacture a shaped product by using various colors and various materials stored in the tank.

### TECHNICAL FIELD

The present invention relates to a three-dimensional printer and more specifically, to a three-dimensional printer capable of piling various materials having various colors.

### DESCRIPTION OF THE RELATED ART

A three-dimensional printer is a device for manufacturing a physical 3D object on the basis of a three-dimensional design made through a computer program. Three-dimensional printing largely falls into three categories depending on materials used for 3D printing. First, fused deposition modeling (FDM) is a technology where solid filaments are used as a raw material. Second, digital light processing (DLP) is a technology where liquid materials are used as a raw material. Finally, selective laser sintering (SLS) is a technology where powdered materials are used as a raw material.

In recent years, a DLP-type 3D printer has been most widely used to produce micro forms. In the case of a DLP-type 3D printer, ultra ray (UV) curable resins that are cured with ultraviolet light are used as a raw material. In general, such a DLP-type 3D printer includes a resin storing part that stores UV curable resins, a light radiating part that radiates ultraviolet light onto the resin storing part, and a substrate part where resins cured by the light radiating part are piled. Korean Patent No. 10-1647799 discloses a DLP-type 3D printer.

However, such a DLP-type 3D printer may only manufacture a shaped product that consists of a single material and that has a single color.

Accordingly, there is a need to develop a technology to solve the above-described problem.

Meanwhile, the above-described related art is technical information retained by this applicant for drawing the present invention, or obtained by this applicant during the process of drawing the present invention. Accordingly, it cannot be said that the above-described related art is a well-known technology that went public prior to the application of the present invention.

### DETAILED DESCRIPTION OF THE INVENTION

### Technical Problems

The present invention is directed to providing a three-dimensional printer.

### Technical Solutions

According to one aspect of the present invention, a three-dimensional printer as a means to achieve the above-described aim includes a plurality of tanks storing liquid materials therein, a light radiating unit disposed at the lower portion of the plurality of tanks so as to radiate light, a switching unit disposed at the bottom of the tanks so as to transmit light corresponding to an axial direction cross sectional image of a shaped product formed in the tanks, out of light radiated by the light radiating unit; and a forming stage where a shaped product is formed at the lower portion thereof is configured to move up and down.

### Advantageous Effects

A three-dimensional printer according to an embodiment of the present invention includes a plurality of tanks providing different photocurable liquid resins so as to generate various shaped products.

A three-dimensional printer according to an embodiment of the present invention is designed to cure various materials contained in a plurality of tanks with a single LED with no need to install light sources at each tank.

A three-dimensional printer according to an embodiment of the present invention may generate different-colored structures compared to conventional three-dimensional printers by taking a voxel as a basic unit of colors of an output.

A three-dimensional printer according to an embodiment of the present invention includes a plurality of tanks so as to manufacture various shaped products that consist of different materials and have different colors.

Shaped products, generated by a three-dimensional printer according to an embodiment of the present invention, form voxels by using a variety of colors, and the colors of voxels themselves may change depending on the arrangement of colors.

A cleanser may be stored in any one of the tanks included in a three-dimensional printer according to an embodiment of the present invention, and a cleansing unit is disposed between tanks adjacent to each other so as to clean a shaped product.

Advantages of the present invention are not limited to the above-described advantages, and other advantages of the present invention that have not been described, will be apparent to one of ordinary skill in the art to which the present invention pertains from the following description.

### BRIEF DESCRIPTION OF THE DRAWINGS

FIG. 1 is a perspective view illustrating a configuration of a three-dimensional printer according to an embodiment of the present invention.

FIG. 2 is a plan view illustrating a configuration of a three-dimensional printer according to an embodiment of the present invention.

FIG. 3 is a front view illustrating a configuration of a three-dimensional printer according to an embodiment of the present invention.

FIG. 4 is a plan view illustrating a configuration of a three-dimensional printer according to another embodiment of the present invention.

FIG. 5 is a front view illustrating a configuration of a three-dimensional printer according to another embodiment of the present invention.

FIG. 6 is a view illustrating a theory in which a color of a voxel constituting a shaped structure printed out by a three-dimensional printer according to an embodiment of the present invention is formed.

### MODE FOR CARRYING OUT THE INVENTION

Below, embodiments of the present invention will be described in detail with reference to the attached drawings such that one of ordinary skill in the art to which the present invention pertains can easily embody the present invention. However, the present invention may be embodied in various forms, and should not be construed as being limited to the embodiments set forth herein. Further, what is irrelevant to the description of the present invention will be excluded from the attached drawings so as to describe the present invention clearly, and like reference numerals denote like elements throughout the specification.

It should be understood that when an element is “connected” to another element, it means that one element may be “directly connected” to another element and that a third element may exist between one element and another element such that one element is “electrically connected” to another element. It should be further understood that the term “comprise” means including any other element but not precluding any another element unless specifically described to the contrary.

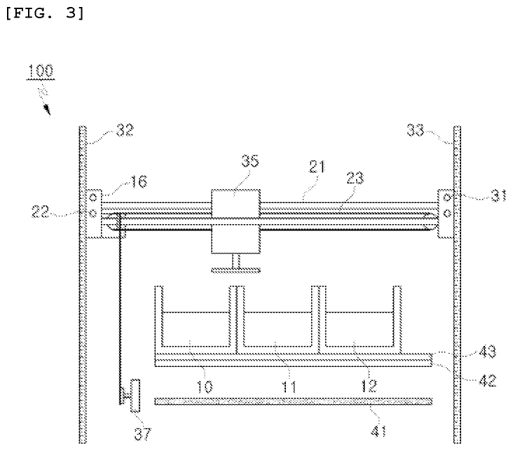

In this specification, the terms “left’ and “right” are used to describe a position of a specific element in FIG. 3 but do not mean that the specific element is positioned on the left and on the right.

Like reference numerals denote like elements even when the like elements are illustrated in different drawings. Further, if necessary, elements in another drawing may be cited when a drawing is described.

Below, a three-dimensional printer 100 according to an embodiment of the present invention will be described in detail with reference to the attached drawings.

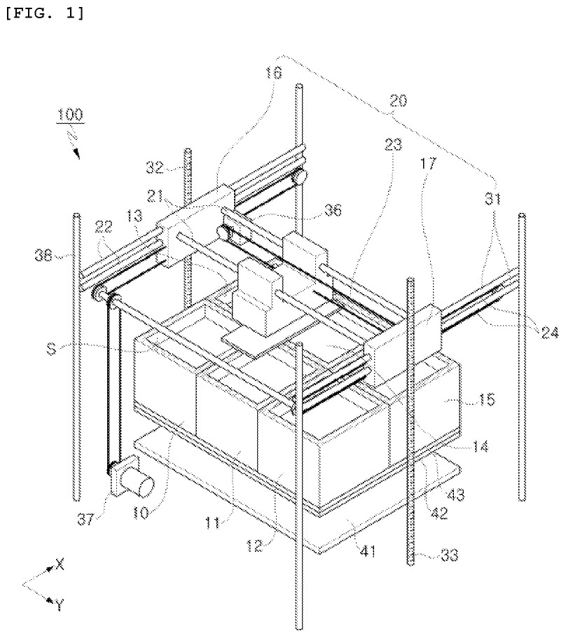

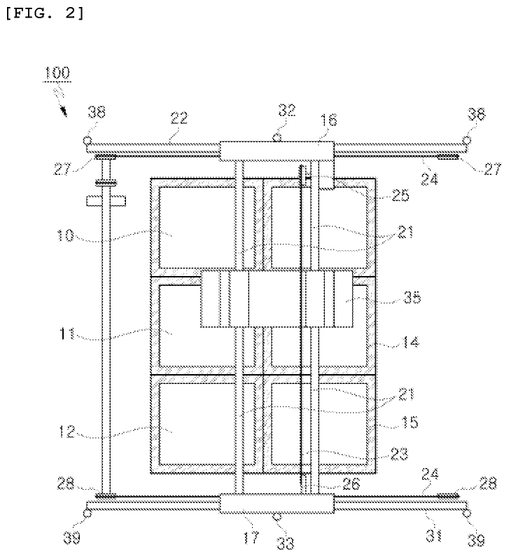

FIG. 1 is a perspective view illustrating a configuration of a three-dimensional printer 100 according to an embodiment of the present invention, FIG. 2 is a plan view illustrating a configuration of a three-dimensional printer 100 according to an embodiment of the present invention, and FIG. 3 is a front view illustrating a configuration of a three-dimensional printer 100 according to an embodiment of the present invention.

A three-dimensional printer 100 according to an embodiment of the present invention may include at least one tank 10 to 15. The tank 10 to 15 is an element and a device that can store liquid materials necessary for creating a formed structure.

The tank 10 to 15 has a rectangular parallelepiped shape whose top is opened, and has a storing space S therein, in which a liquid material may be stored. The tank 10 to 15 may consist of a fluororesin film while the liquid material stored in the storing space S may include a curing resin or a resin (a material in which a photocurable plastic is melted) etc. that are cured by ultraviolet rays. The curable resin or resin is presented only as an example. Accordingly, any material that may be cured by ultraviolet rays may be stored in the tank 10 to 15.

Meanwhile, the tank 10 to 15 may be arranged at the same height, and the arrangement and number of the tanks 10 to 15 may be determined on the basis of the sort and number of liquid materials.

That is, each tack 10 to 15 included in a three-dimensional printer 100 according to an embodiment of the present invention may store liquid materials that differ in color and that consist of different materials, and a cleanser for washing the liquid materials. The number, arrangement and position of the tanks may be determined on the basis of the sort and color of the liquid materials. For instance, a plurality of the tanks 10 to 15, as illustrated in FIGS. 1 to 3, may be positioned in the X-axis and Y-axis directions.

Specifically, if only six colors (e.g. magenta, yellow, cyan, black, white and transparent colors) except the cleanser are used to obtain a shaped product, six tanks 10 to 15 may be positioned in the three-dimensional printer 100 so as to store different color liquid materials and may be positioned at the same height such that six tanks are positioned in groups of three in the X-axis direction of the three-dimensional printer 100 and positioned in groups of two in the Y-axis direction of the three-dimensional printer 100, as illustrated in FIG. 1. Additionally, as another example, if a liquid material with another color and a cleanser, besides the six color liquid materials, are used to obtain a shaped product, a total of eight tanks may be positioned in the three-dimensional printer such that eight tanks are positioned in groups of four in the X-axis direction of the three-dimensional printer 100 and positioned in groups of two in the Y-axis direction of the three-dimensional printer 100.

Meanwhile, a three-dimensional printer 100 according to an embodiment of the present invention may include a cleansing unit (invisible).

If a forming stage 35 that will be described hereunder moves into a certain tank 11 to 15 and then move into another tank 11 to 15, liquid materials can be left. In this case, the cleansing unit (invisible) removes the left liquid materials.

The cleansing unit (invisible) may be positioned between a pair of tanks 11 to 15 adjacent to each other or the outer surfaces of the tanks 11 to 15, and may have any configuration so as to remove the liquid materials left at the forming stage that will be described hereunder. For instance, a compressor etc. may be applied to the cleansing unit (invisible) so as to blow compressed air.

In this case, if compressed air is perpendicularly blown at the lower portion of the forming stage 35, there is a possibility that the left liquid material is not discharged out of the forming stage 35. Accordingly, compressed air may be obliquely blown at the lower portion of the forming stage 35.

Meanwhile, the three-dimensional printer 100 may include a stage transferring unit 20 supporting the forming stage 35 so as to move the forming stage in the X-axis and Y-axis directions.

The stage transferring unit 20 may include a pair of moving frames 16, 17 and may include at least one first axis guide rod 21 extending from any one of the pair of moving frames 16, 17 to the other.

First, the pair of moving frames 16, 17 may be positioned at both sides of the tanks so as to face each other, the upper portion of each of the pair of moving frames 16, 17 may be disposed at a position higher than the position of the tanks 10 to 15, and each moving frame 16, 17 may move along a second axis guide rod 22 and a third axis guide rod 23. This will be described below.

Meanwhile, the forming stage 35 may slide along the first guide rod 21.

Specifically, a through hole (invisible) may be formed at the forming stage 35, and the first axis guide rod 21 may penetrate into and connect with the through hole. The forming stage 35 coupled to a first axis driving belt 22 moves along the first axis guide rod 21 as the first axis driving belt 22 rotates.

Specifically, the forming stage 35, as illustrated in FIGS. 1 to 3, moves from the first moving frame 16 to the second moving frame 17, or from the second moving frame 17 to the first moving frame 16 as the driving belt 22 is wound around a pair of first axis pulleys 25, 26 and rotates.

Further, the stage transferring unit 20 may include a second axis guide rod 22 and a third axis guide rod 31, and the forming stage 35 may slide along the second axis guide rod 22 and the third axis guide rod 31.

Specifically, the second axis guide rod 22 penetrates into and connects with the first moving frame 16 positioned on the left, out of both ends of the first axis guide rod 21 in the lengthwise direction thereof, and the third axis guide rod 31 penetrates into and connects with the second moving frame 17 positioned on the right, out of both ends of the first axis guide rod 21 in the lengthwise direction thereof such that the first moving frame 16 and the second moving frame 17 slide along the second axis guide rod 22 and the third axis guide rod 31. By doing so, the forming stage 35 also moves along the second axis guide road 22 and the third axis guide rod 31.

Meanwhile, a three-dimensional printer 100 according to an embodiment of the present invention may include at least one position adjusting motor 36, 37. The position adjusting motors 36, 37 are configured to receive electric energy so as to provide mechanical energy such that the pulleys 25, 26, 27, 28 and the driving belts 23, 24 swivel.

Specifically, the first position adjusting motor 36, as illustrated in FIGS. 1 to 3, may be positioned at any one of the first moving frame 16 and the second moving frame 17. If the first position adjusting motor 36 is positioned at the first moving frame 16, the left first axis pulley 25 swivels, and if the first position adjusting motor 36 is positioned at the second moving frame 17, the right first axis pulley 26 swivels, while the first axis driving belt 23 wound around the left first axis pulley 25 and the right first axis pulley 26 also swivels.

Further, the second position adjusting motor 37 may be disposed at a certain position. Driving force generated from the second position adjusting motor 37 is delivered respectively to the second axis pulleys 27, 28 so as to swivel the second axis driving pulleys 27, 28 and the second axis driving belt 24 that are wound around the second axis pulleys 27, 28. Finally, the first moving frame 16 and the second moving frame 17 move along the second axis guide rod 22 and the third axis guide rod 31.

Meanwhile, a three-dimensional printer 100 according to an embodiment of the present invention may include a pair of actuators 32, 33 and two pairs of perpendicular guide rods 38, 39. Each of the actuators 32, 33 uses an LM guide and a ball screw so as to adjust the height of an element connected to the actuator 32, 33. Detailed description regarding this will not be provided because this is well-known.

According to a three-dimensional printer 100 of an embodiment of the present invention, the heights of the second axis guide rod 22 and the third axis guide rod 31 may be adjusted by a pair of actuators 32, 33. By doing so, the height of the forming stage 35 may also be adjusted. Specifically, the left actuator 32 is disposed between a pair of left perpendicular guide rods 38 and disposed at the center of both ends of the second axis guide rod 22 in the lengthwise direction thereof, and the right actuator 33 is disposed between a pair of right perpendicular guide rods 39 and disposed at the center of both ends of the third axis guide rod 31 in the lengthwise direction thereof, such that the heights of the second axis guide rod 22 and the third axis guide rod 31 are adjusted.

Meanwhile, a three-dimensional printer 100 according to an embodiment of the present invention may include a forming stage 35.

The forming stage 35 to which a shaped product obtained by means of the curing of inks may be configured to have a proper shape such that the shaped product is attached.

Specifically, as illustrated in FIG. 1, a cross section of each of the tanks 11 to 15, which are parallel to the ground surface, is configured as a rectangle in the axial direction, and a cross section of the lower surface of the forming stage 35 may be configured as a rectangle that is proper for the forming stage 35 so as to go into each of the tanks 11 to 15 and to attach the shaped product.

Additionally, the rectangular plate-shaped forming stage has been provided only as an example. If a three-dimensional printer 100 according to an embodiment of the present invention includes a tank with a circular cross section parallel to the ground surface, the forming stage 35 may be configured to have a cylindrical shape.

More specifically, the forming stage 35 may be configured to move up and down and may have a shaped product at the lower portion thereof. If the forming stage 35 moves down and is disposed near the bottom of the tank 11 to 15, a light radiating unit 41 radiates light towards the tank, liquid materials are cured by the light radiated by the light radiating unit 41, a shaped product is formed at the lower portion of the forming stage 35, and then the forming stage moves up again.

Meanwhile, a three-dimensional printer 100 according to an embodiment of the present invention may include a light radiating unit 41.

The light radiating part 41 is disposed at the lower portion of each of the tanks 11 to 15 so as to cure the liquid materials stored in the tanks 11 to 15.

The light radiating unit 41 may be configured to radiate enough light to each of the tanks 11 to 15. For instance, a plurality of light-emitting diodes (LED) radiating light ranging from 390 nm to 420 nm may be arranged in the X-axis and Y-axis directions. If the light radiating unit 41 consists of a plurality of LEDs, the light radiating unit 41 evenly radiates light on the entire surface towards the tanks 11 to 15 unlike conventional projectors.

Specifically, the light radiating units 41 may be disposed so as to correspond to each of the tanks 11 to 15, a single light radiating unit 41 may be formed so as to correspond to a total of the X-Y axial direction cross sections of all the tanks 10 to 15, or a light radiating unit 41 may be disposed so as to correspond to each group after certain tanks 11 to 15 are formed into groups.

A three-dimensional printer 100, as illustrated in FIG. 2, includes a single light radiating unit 41 so as to correspond to the X-Y axial direction cross sections of all the tanks 10 to 15, and the light radiating unit 41 is configured to radiate light onto all the tanks 10 to 15. A switching unit 43 that will be described below may selectively transmit the light radiated onto each of the tanks 11 to 15 by means of the light radiating unit 41.

Meanwhile, a three-dimensional printer 100 according to an embodiment of the present invention may include a supporting unit 42.

The supporting unit 42 may consist of glass with high light transmission so as to increase the intensity of the switching unit 43. The supporting unit 42 may consist of a material that is more ductile and malleable than that of the switching unit 43 that will be described below, and may consist of a material that is stronger than that of the switching unit 43 so as to resist shocks, shear force and tensile stress. The supporting unit 42 may be attached to the lower portion of the switching unit 43 so as to increase the intensity of the switching unit 43 even when a force strong enough to damage the switching unit 43 is exerted on the switching unit 43, thereby preventing damage to the switching unit 43.

Further, the supporting unit 42 may consist of a transparent material that can transmit light such as diamant glass, transparent plastics etc. Diamant glass, transparent plastics etc. are presented only as examples. Accordingly, any transparent materials may be applied to the supporting unit 42.

Meanwhile, a three-dimensional printer 100 according to an embodiment of the present invention may include a switching unit 43.

The switching unit 43 is disposed at the bottom of the tanks 11 to 15 so as to selectively transmit light corresponding to the axial direction (X-Y axis) cross sectional image of a shaped product formed in the tanks 11 to 15, out of the light radiated by the light radiating unit 41.

Specifically, the switching unit 43 may be configured as a liquid crystal display (LCD), and the light radiated by the light radiating unit 41 may be transmitted through the LCD or may not be transmitted through the LCD according to whether an electric current is applied to the LCD. The method for operating an LCD will not be described in detail because it is well-known.

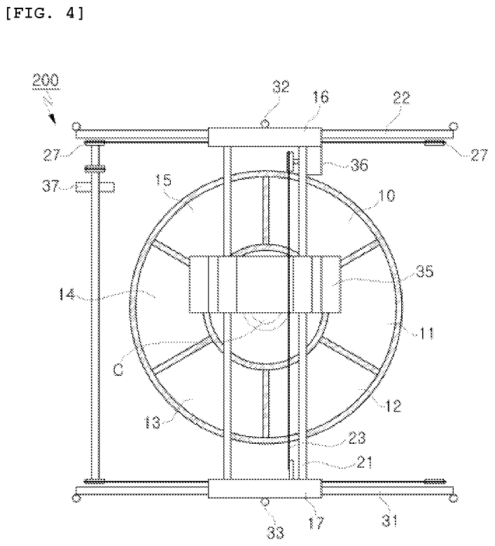

Meanwhile, the configuration of a three-dimensional printer 200 according to another embodiment of the present invention will be described hereunder with reference to FIGS. 3 to 4.

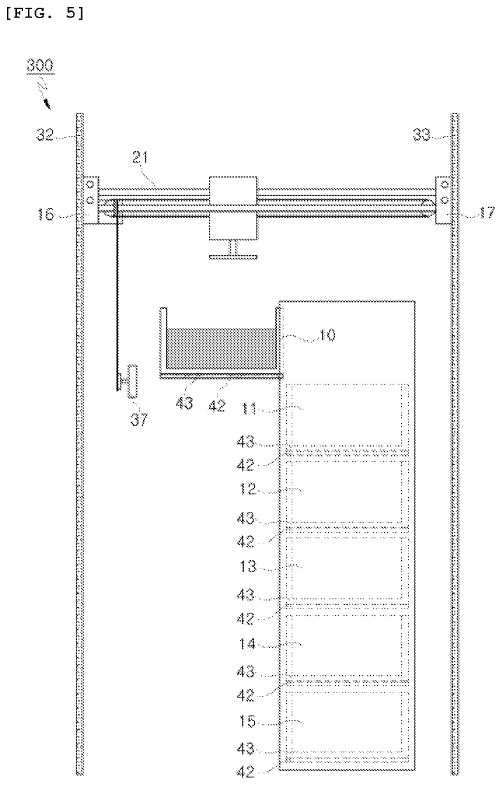

FIG. 4 is a plan view illustrating a configuration of a three-dimensional printer 200 according to another embodiment of the present invention, and FIG. 5 is a front view illustrating a configuration of a three-dimensional printer 300 according to another embodiment of the present invention.

Unless additional technologies of another embodiment of the present invention that will be described below are disclosed, all the configurations included in a three-dimensional printer 200, 300 according to the above-described embodiment of the present invention are construed as being included in another embodiment of the present invention.

According to a three-dimensional printer of another embodiment of the present invention, tanks 10 to 15 may be disposed at the same height in a circular way so as to swivel around the central axis C, and a swiveling motor (invisible) may be disposed at the central axis of the tanks 10 to 15.

Specifically, according to a three-dimensional printer of another embodiment of the present invention, if a certain material is used to form a shaped structure, tanks 11 to 15 storing the material move to the lower portion of the forming stage 35, and the forming stage 35 moves up and down at the upper portion of the tanks 11 to 15 disposed at the lower portion of the forming stage 35 so as to form a shaped structure, as illustrated in FIG. 4.

The theory of swiveling a circular structure with a swiveling motor will not be described in detail because it is well-known.

Further, according to a three-dimensional printer of another embodiment of the present invention, tanks 10 to 15 are arranged up and down with respect to each other, and may selectively move to the lower portion of the forming stage 35.

Specifically, according to a three-dimensional printer of another embodiment of the present invention, tanks 10 to 15 may be disposed in the form of a chest of drawers, as illustrated in FIG. 5. A supporting unit 42 and a switching unit 43 may be disposed at the lower portion of each of the tanks 10 to 15. Light radiating units 41 may also be disposed respectively at the lower portions of the switching units 43. When each of the tanks 10 to 15 selectively moves to the lower portion of the forming stage 35, the supporting unit 42 and the switching unit 43 that are disposed at the lower portion of each tank 10 to 15 may also move, and any one of an actuator, a motor, a hydraulic cylinder and a pneumatic cylinder may be disposed at one side of the tanks 10 to 15 so as to move the tanks 10 to 15.

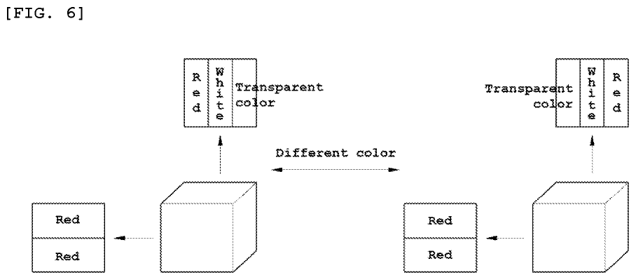

Below, features of a shaped product formed by a three-dimensional printer 100, 200, 300 according to an embodiment of the present invention will be described with reference to FIG. 6. FIG. 6 is a view illustrating a theory in which a voxel color, constituting a shaped structure printed out by a three-dimensional printer according to an embodiment of the present invention, is formed.

The smallest unit consisting of a two-dimensional image, or a small square dot is referred to as a pixel. The quality of an image is determined by the number of pixels consisting of the image. Each pixel displays colors by a combination of red, green and blue.

An image generated by a three-dimensional printer is three-dimensional. Accordingly, instead of a pixel in a two-dimensional image, the term voxel is used to refer to the image generated by a three-dimensional printer. That is, a shaped product consisting of a large number of voxels is a product of a high standard and of a high quality.

A voxel, as illustrated in FIG. 6, is a three-dimensional unit, and the color of a voxel changes according to the colors included in the voxel, the positions of the colors, and the direction in which a person sees the voxel. Accordingly, the color included in the voxel, and the position of the color included in the voxel as well have to be determined so as to decide on the color of a certain voxel.

The descriptions of the present invention have been provided as an example, and it will be understood that one of ordinary skill in the art to which the present invention pertains may modify the present invention in different forms without departing from the technical spirit and essential features of the present invention. Thus, it should be understood that the embodiments set forth herein have been provided only as examples but not intended to limit the present invention. For instance, elements described as an integrated form may be separately embodied, and elements described as a separated form may be integrally embodied.

The scope of the present invention should be determined by the attached claims rather than the description of the invention, and all the meanings and scope of the claims, and all the modifications or modified forms drawn from equivalents should be construed as being included in the scope of the present invention.

1. A three-dimensional printer comprising:
a plurality of tanks storing liquid materials therein;
a light radiating unit disposed at the lower portion of the plurality of tanks so as to radiate light;
a switching unit disposed at the bottom of the tanks so as to selectively transmit light corresponding to an axial direction cross sectional image of a shaped product that will be formed in the tanks, out of light radiated by the light radiating unit; and
a forming stage, where a shaped product is formed at the lower portion thereof, configured to move up and down.

2. The three-dimensional printer according to claim 1, wherein a cleansing unit for discharging air is provided between tanks adjacent to each other among the plurality of the tanks so as to remove impurities from the shaped product formed at the lower portion of the forming stage.

3. The three-dimensional printer according to claim 2, wherein the plurality of tanks are disposed in the X-axis and Y-axis directions,
the three-dimensional printer comprises a stage transferring unit supporting the forming stage such that the forming stage move in the X-axis and Y-axis directions.

4. The three-dimensional printer according to claim 3, wherein the switching unit is configured as a liquid crystal display.

5. The three-dimensional printer according to claim 4, wherein the supporting unit is disposed at the lower portion of the switching unit so as to increase intensity of the switching unit.

6. The three-dimensional printer according to claim 5, wherein the light radiating unit comprises a plurality of light emitting diodes arranged in the X-axis and Y-axis directions.

7. The three-dimensional printer according to claim 1, wherein the plurality of tanks are disposed at the same height in a circular way so as to swivel around the central axis,
the three-dimensional printer comprises a swiveling unit swiveling the plurality of tanks arranged in a circular way

8. The three-dimensional printer according to claim 1, wherein the plurality of tanks are arranged up and down with respect to each other, and selectively moving to the lower portion of the forming stage.
